(19) United States
(12) Patent Application Publication
(10) Pub. No.: US 2009/0300478 A1
(43) Pub. Date: Dec. 3, 2009

(54) IMAGE FORMING APPARATUS, INFORMATION PROCESSING METHOD AND PROGRAM

(75) Inventor: DAISUKE KONDO, Tokyo (JP)

Correspondence Address: IPUSA, P.L.L.C, 1054 31ST STREET, N.W., Suite 400, Washington, DC, 20007, US

(73) Assignee: RICOH COMPANY, LTD.

(21) Appl. No.: 12/426,347

(22) Filed: Apr. 20, 2009

(30) Foreign Application Priority Data
May 30, 2008 (JP) 2008-143132

(51) Int. Cl. G06F 17/00; G06F 17/30

(52) U.S. Cl. 715/234; 715/810; 707/E17.008

(57) ABSTRACT

An image forming apparatus includes multiple executing units; multiple Webpage generating units each corresponding to an executing unit and configured to execute a process corresponding to an HTTP request and generate a Web page for displaying information indicating the process result; multiple menu-information integrating units, each corresponding to an executing unit and configured to obtain, from each Webpage generating unit corresponding to the executing unit, a URL of the Webpage generating unit and menu-item display information provided for allowing use of the Webpage generating unit, integrate and store the menu-item display information in a first file specific to the executing unit, and merge, with the first file, information obtained from another first file specific to another executing unit; and a menu-page generating unit configured to generate, based on information stored in the merged first file, a Web page including menu items provided for allowing use of the Webpage generating units.

### BACKGROUND OF THE INVENTION

1. Field of the Invention

The present invention is directed to an image forming apparatus, an information processing method and a program, and in particular to an image forming apparatus, an information processing method and a program for providing a Web site.

2. Description of the Related Art

Conventionally, Web systems are in wide use as an infrastructure to use applications via a network. In a Web system, applications are implemented as Web applications on a server computer which is called a Web server or an application server. A unique URL (Uniform Resource Locator) is assigned to each Web application. A client (such as a Web browser) specifies a URL corresponding to a desired Web application and transmits an HTTP request, whereby it is possible to display a user interface (Web page) of the Web application and execute business logic implemented on the Web application.

In recent years, there are image forming apparatuses such as copy machines, printers, fax machines and multi-function peripherals (MFPs), functions of which are provided by Web applications. With such an image forming apparatus, the user inputs an URL of the function (Web application) that he/she wants to use using a Web browser or the like, thereby making the user able to remotely use the function.

### [Patent Document 1] Japanese Laid-open Patent Application Publication No. 2004-318842

However, for users, an image forming apparatus is a single apparatus, and it is therefore desirable to create an environment seen by the users as a single Web site rather than a collection of multiple Web applications.

On the other hand, with the recent development of software component technology, each Web application has an increasingly higher degree of independence. Accordingly, with functional enhancement of the image forming apparatuses, today it is possible to flexibly add new Web applications.

Therefore, it is desired not only to make multiple Web applications seen as a single integrated Web site but also to create a Web site capable of flexibly dealing with changes in the structure of Web applications.

### SUMMARY OF THE INVENTION

In view of the above aspects, the present invention aims at providing an image forming apparatus, an information processing method and a program capable of appropriately integrating multiple Web applications.

In order to solve the above issues, one aspect of the present invention is an image forming apparatus including multiple program executing units; multiple Web page generating units, each corresponding to one of the program executing units and configured to execute a process that corresponds to an HTTP request and generate a Web page for displaying information indicating a result of the process; multiple menu information integrating units, each corresponding to one of the program executing units and configured to obtain, from each of the Web page generating units corresponding to the corresponding program executing unit, a URL of each of the Web page generating units and menu item display information provided for allowing use of the Web page generating units, integrate and store the obtained menu item display information in a first file specific to the corresponding program executing unit, and merge, with the first file, information obtained from another first file specific to another program executing unit; and a menu page generating unit configured to generate, based on information stored in the merged first file, a Web page including menu items provided for allowing use of the Web page generating units.

### BRIEF DESCRIPTION OF THE DRAWINGS

FIG. 1 illustrates a structural example of a program execution environment of an MFP according to the first embodiment;

FIG. 2 illustrates a structural example of multiple bundles used for achieving an integrated Web site according to the first embodiment;

FIG. 3 shows an example of a display of a menu page according to the first embodiment;

FIG. 4 illustrates a process of generating an integrated configuration file and an integrated menu file;

FIG. 5 is a sequence diagram illustrating, according to the first embodiment, operating procedures performed when a Web UI content bundle is added;

FIG. 6 illustrates a structural example of a program execution environment of an MFP according to the second embodiment;

FIG. 7 shows an example of a bundle structure for realizing an integrated Web site according to the second embodiment;

FIG. 8 illustrates information exchanges between Web UI framework bundles;

FIG. 9 illustrates, according to the second embodiment, operating procedures performed when an HTTP request is received; and

FIG. 10 is a sequence diagram illustrating, according to the second embodiment, operating procedures performed when a Web UI content bundle is added.

### DETAILED DESCRIPTION OF THE PREFERRED EMBODIMENTS

Embodiments that describe the best mode for carrying out the present invention are explained next with reference to the drawings. The present embodiment is described taking an MFP as an example of the image forming apparatus. The MFP is an image forming apparatus which is a single unit device serving multiple functions of a printer, a copying machine, a scanner, a fax machine and the like.

### (a) First Embodiment

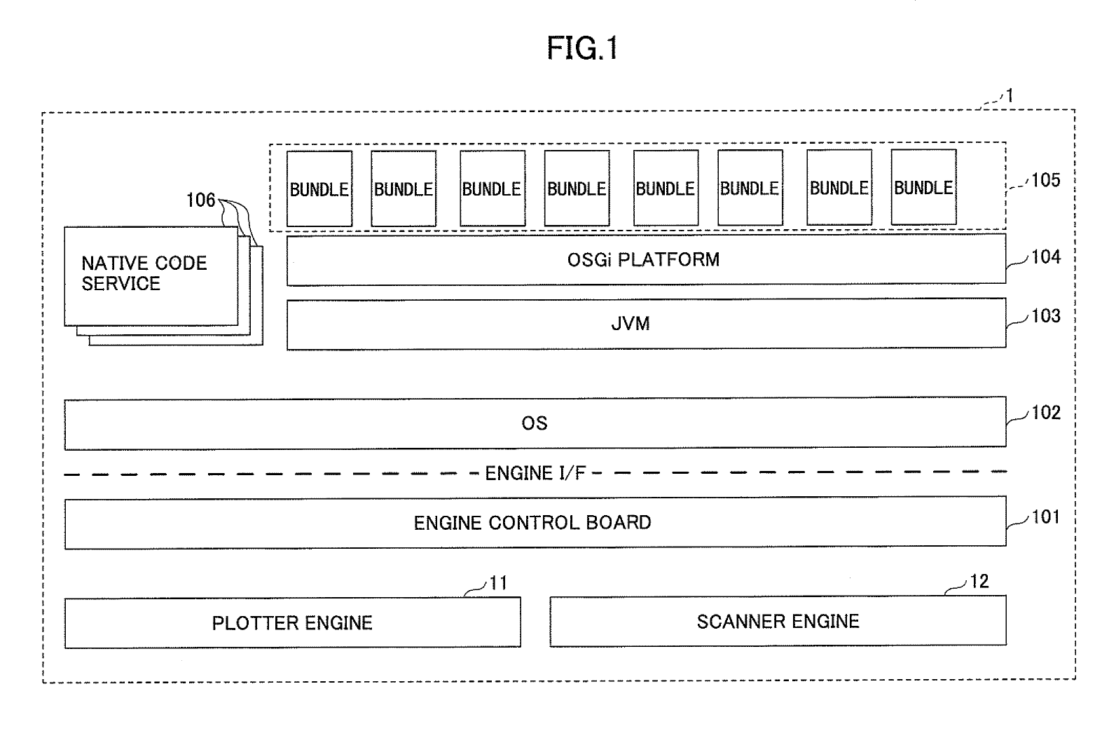

FIG. 1 illustrates a structural example of a program execution environment of the MFP according to the first embodiment.

According to FIG. 1, an MFP 1 includes a plotter engine 11 and a scanner engine 12 as a part of the hardware resources and an engine control board 101, an OS 102, a JVM (Java (registered trademark) Virtual Machine) 103, an OSGi (Open Services Gateway Initiative) platform 104, bundles 105, native code services 106 and the like as a part of the software resources. The software resources are recorded in a memory (not shown) of the MFP 1, and functions of the software resources are performed by causing a CPU (not shown) of the MFP 1 to execute implemented operating procedures.

The engine control board 101 controls individual functions of the MFP 1, such as the plotter engine 11 and the scanner engine 12, and provides its own functions to the OS 102 or the like via an engine I/F (interface).

The OS 102 is an operating system, and runs as a process the JVM 103, each native code service 106 and the like in parallel. The JVM 103 converts bytecode unique to the Java (registered trademark) language to native code operable on the OS 102, which then executes the converted native code. The OSGi platform 104 is standardization technology produced by the OSGi Alliance, and is a software platform for providing an execution environment of software components which are produced on the basis of open software component technologies based on the Java (registered trademark) language. On the OSGi platform 104, Java (registered trademark) language software is implemented in the form of software components called “bundles”. A bundle is formed of a single JAR (Java (registered trademark) ARchive) file, and each bundle can be independently and dynamically (without requiring restart of the MFP 1) installed. The bundles 105 illustrated in FIG. 1 represent such bundles. As shown in FIG. 1, multiple bundles 105 may be provided. The native code service 106 is a program written in native code, e.g. the C language, that directly executes on the OS 102, and there are one or more native code services 106, as shown in FIG. 1. Each native code service 106 performs various functions that are, for example, commonly used by multiple bundles 105. For a call (use) of a native code service 106 by a bundle 105 which is run on the JVM 103 as a thread, the JNI (Java (registered trademark) Native Interface) may be used, for example.

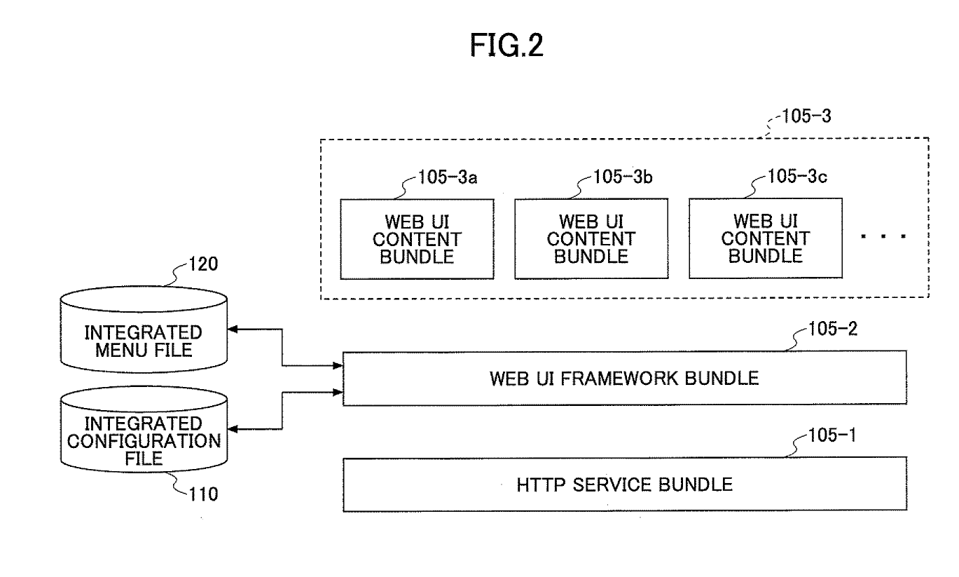

Among such software resources, a Web site is achieved by multiple bundles 105 in the MFP 1. FIG. 2 illustrates a structural example of multiple bundles used for realizing an integrated Web site according to the first embodiment.

FIG. 2 shows an HTTP service bundle 105-1, a Web UI framework bundle 105-2 and Web UI content bundles 105-3 including multiple Web UI content bundles 105-3a, 3b, 3c and the like. Each of these bundles corresponds to a single bundle 105 of FIG. 1. That is, FIG. 2 depicts the relationship (hierarchical relationship) of, among all bundles 105 shown in FIG. 1, bundles 105 used for realizing a Web site.

The HTTP service bundle 105-1 functions as a HTTP server (HTTP daemon). That is, the HTTP service bundle 105-1 controls HTTP communications, such as reception of an HTTP request from a client (Web browser or the like) and transmission of an HTTP response to the client.

Each Web UI content bundle 105-3 functions as a Web application. That is, a unique URL (Uniform Resource Locator) is assigned to each Web UI content bundle 105-3. Each Web UI content bundle 105-3 performs a unique business logic process in response to an HTTP request which specifies the URL assigned to the Web UI content bundle 105-3, and generates Web UI content (a Web page, such as HTML data) for displaying the result of the process.

The Web UI framework bundle 105-2 integrates multiple independent Web UI content bundles 105-3, and performs a process for realizing a single Web site. The integration of multiple Web UI content bundles 105-3 includes, for example, management of information common to the multiple Web UI content bundles 105-3 (e.g. session information, authentication information, and language (display language) information); determination of a Web UI content bundle 105-3 corresponding to an URL specified in an HTTP request (i.e. distribution of an HTTP request); and management of menu structure information of multiple Web UI content bundles 105-3.

The distribution of an HTTP request is performed based on an integrated configuration file 110. The integrated configuration file includes information showing a correspondence between URLs and Web UI content bundles 105-3 (hereinafter, referred to as “URL correspondence information”)). That is, the Web UI framework bundle 105-2 determines a Web UI content bundle 105-3 corresponding to a URL specified in an HTTP request based on the integrated configuration file 110, and calls and causes the determined Web UI content bundle 105-3 to perform a process corresponding to the HTTP request.

The menu structure information is information in which a hierarchical structure of menus and a correspondence between display information (display strings and the like) and a URL (a Web UI content bundle 105-3) with respect to each menu is defined. The menu structure information is stored in the integrated menu file 120. A menu in this specification refers to a menu on a Web page (menu page), which allows usage of each Web UI content bundle 105-3.

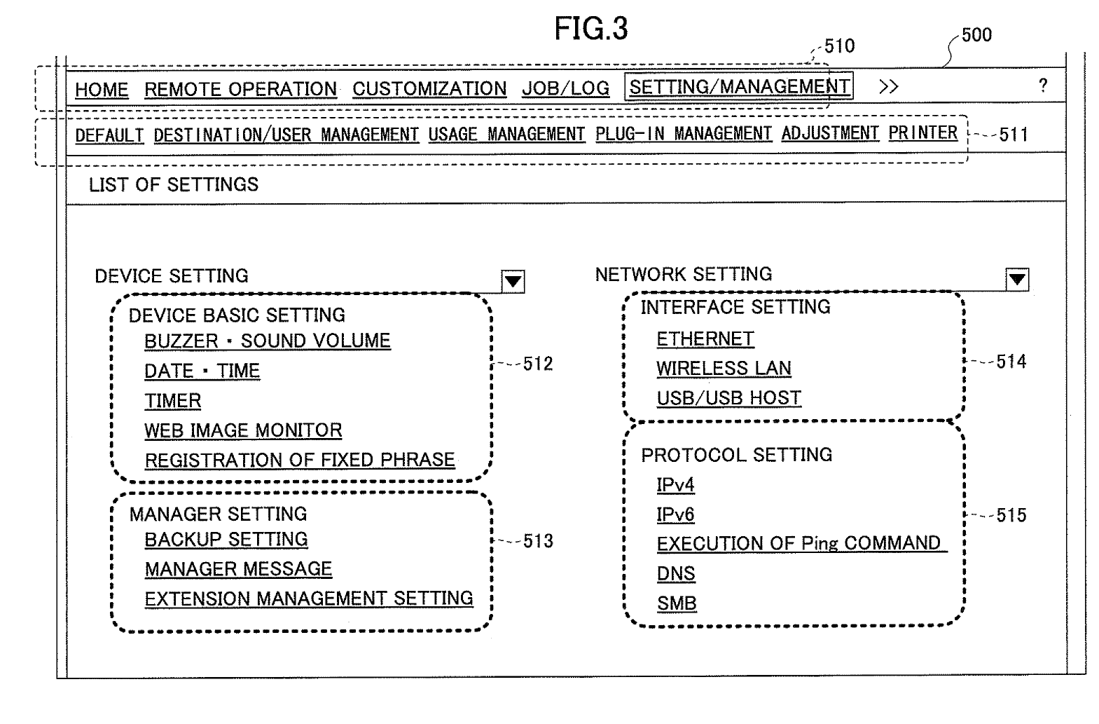

FIG. 3 shows a display example of the menu page according to the first embodiment. In a menu page 500 of FIG. 3, menu items (“home”, “remote operation”, “customization”, “job/log” and “setting/management”) included in a menu 510 are used not for calling Web UI content bundles 105-3 but for following the hierarchical structure of the menu. On the other hand, each menu 511, 512, 513, 514 and 515 is a collection (group) of menu items used for calling Web UI content bundles 105-3. The display contents change according to a menu item selected in the menu 510. That is, a hierarchical relationship (parent-child relationship) is present between the menu items of the menu 510 and the menus 511, 512, 513, 514 and 515. In addition, a hierarchical relationship (parent-child relationship) is also present between the menus 511, 512, 513, 514 and 515 and the menu items included in the respective menus 511, 512, 513, 514 and 515. Note that FIG. 3 shows a menu page in which “setting/management” is selected in the menu 510.

Accordingly, the hierarchical relationship between menu items included in the menu 510 and other menus, URLs corresponding to terminal menu items in the hierarchical relationship, and the like are defined in the menu structure information of the example shown in FIG. 3.

The menu page 500 is created by a Web UI content bundle 105-3 corresponding to a URL of the menu page 500 (for example, the Web UI content bundle 105-3a). Therefore, the integrated menu file 120 is used by the Web UI content bundle 105-3 to create the menu page 500.

The integrated configuration file 110 and the integrated menu file 120 are stored in, for example, an HDD (Hard Disk Drive) of the MFP 1.

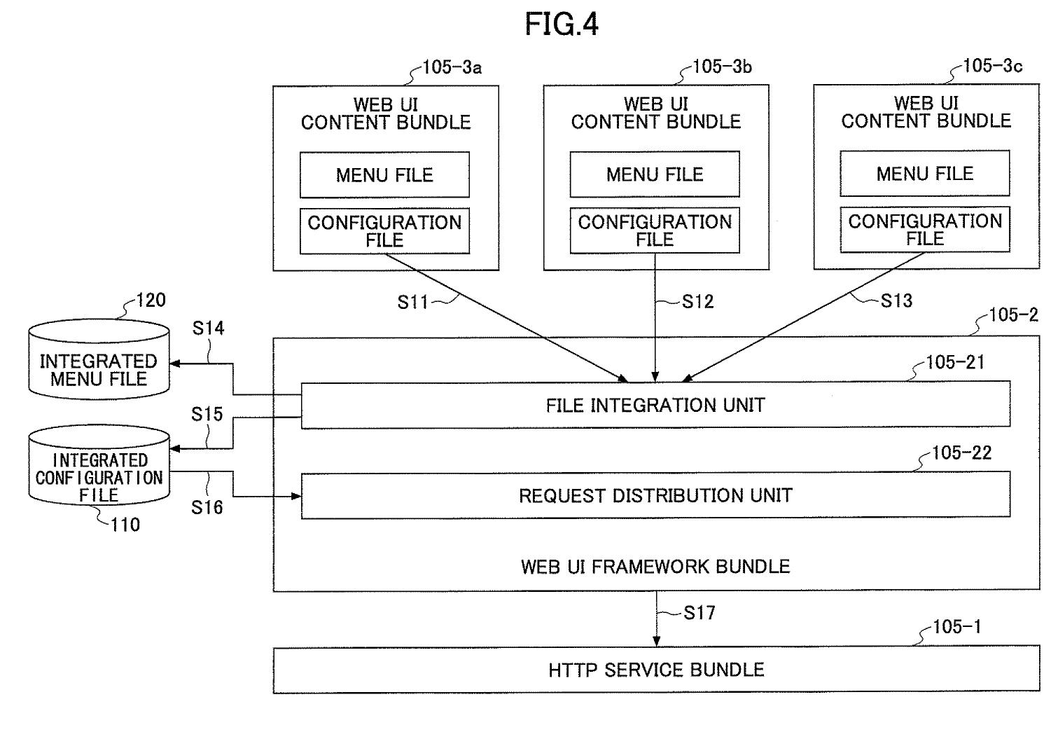

The integrated configuration file 110 and the integrated menu file 120 are automatically generated and updated by the Web UI framework bundle 105-2. FIG. 4 illustrates a process of generating the integrated configuration file 110 and the integrated menu file 120. Note that there is a premise that each Web UI content bundle 105-3 has (i.e. is associated with) a configuration file and a menu file. The configuration file records information indicating a correspondence between (an identification name of) the corresponding Web UI content bundle 105-3 and a URL (this information is referred to as “URL correspondence information”). The menu file records information indicating display contents and positions of the menu items of the corresponding Web UI content bundle 105-3. A position in this specification means a hierarchical structure position of a menu on the menu page 500.

First, each Web UI content bundle 105-3 outputs its menu file and configuration file to a file integration unit 105-21 of the Web UI framework bundle 105-2 (S11, S12 and S13). Alternatively, the file integration unit 105-21 may actively obtain the menu file and the configuration file from each Web UI content bundle 105-3.

Next, the file integration unit 105-21 generates the integrated menu file 120 by integrating the menu files obtained from the individual Web UI content bundles 105-3 (S14). The file integration unit 105-21 generates or updates the integrated configuration file 110 by integrating the configuration files obtained from the Web UI content bundles 105-3 (S15). At this point, the file integration unit 105-21 determines whether there is overlapping in URLs of the Web UI content bundles 105-3. If there is overlapping in the URLs, the file integration unit 105-21 quits generating the integrated configuration file 110 and the like. Note that the integration of the menu files may be achieved by serially arranging descriptive contents of the respective menu files. The integration of the configuration files may be achieved in the same manner.

Subsequently, a request distribution unit 105-22 of the Web UI framework bundle 105-2 obtains the URL correspondence information from the generated or updated integrated configuration file 110 (S16), and registers (reports) a list of URLs included in the URL correspondence information (that is, a list of URLs of Web UI content bundles 105-3 integrated by the Web UI framework bundle 105-2) with the HTTP service bundle 105-1 (S17).

The HTTP service bundle 105-1 receives an HTTP request (for example, an HTTP request transmitted in response to a selection of a menu item made on the menu page 500). In the case where a URL specified in the HTTP request is included in the list reported by the Web UI framework bundle 105-2, the HTTP service bundle 105-1 reports the HTTP request to the request distribution unit 105-22 of the Web UI framework bundle 105-2. The request distribution unit 105-22 determines a Web UI content bundle 105-3 corresponding to the URL of the HTTP request based on the integrated configuration file 110 and calls the determined Web UI content bundle 105-3.

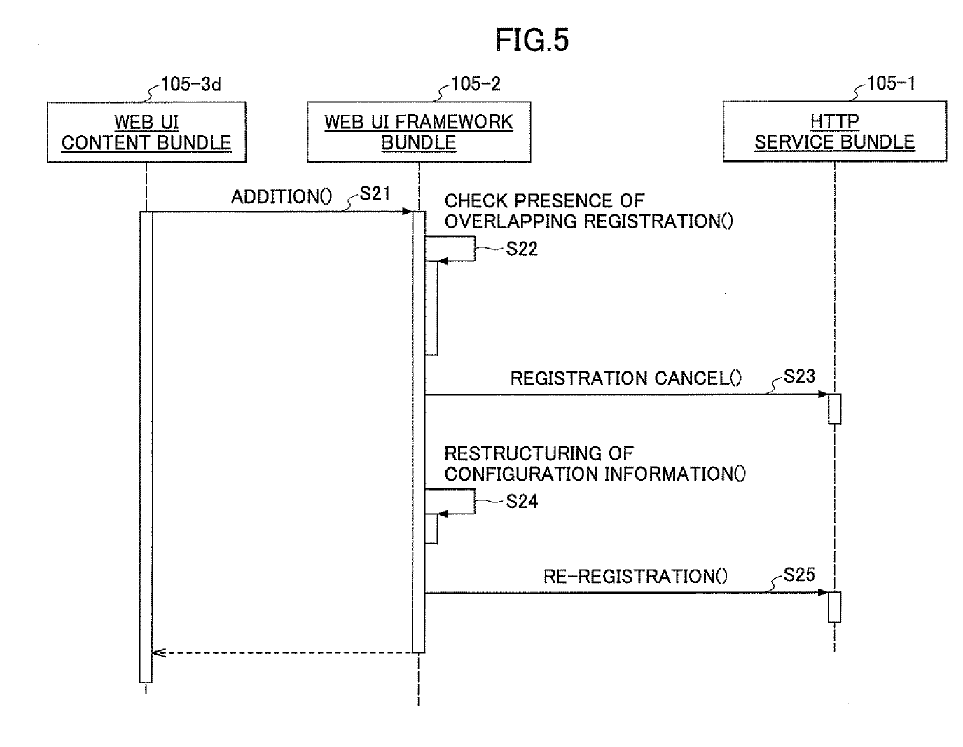

Next is described a process performed when a new Web UI content bundle 105-3 is installed (added) during the operation of the MFP 1. FIG. 5 is a sequence diagram illustrating, according to the first embodiment, operating procedures performed when a Web UI content bundle is added.

Assume that a Web UI content bundle 105-3d is newly installed. Following the installation, the Web UI content bundle 105-3d requests the file integration unit 105-21 of the Web UI framework bundle 105-2 to newly register (add) the menu file and configuration file of the Web UI content bundle 105-3d (S21). Subsequently, the file integration unit 105-21 determines, based on the newly added configuration file of the Web UI content bundle 105-3d and the integrated configuration file 110, whether there is an overlapping URL (S22). If there is an overlapping URL, the file integration unit 105-21 quits the process and displays on a not shown operation panel a message or the like urging change of the overlapping URL.

If there is no overlapping URL, the file integration unit 105-21 requests the HTTP service bundle 105-1 to cancel the registration of the list of URLs (S23). Accordingly, the HTTP service bundle 105-1 cancels the list of URLs registered in Step S17 of FIG. 4, whereby reporting of HTTP requests related to URLs included in the list is stopped.

Subsequently, the file integration unit 105-21 adds contents of the menu file and the configuration file of the Web UI content bundle 105-3d to the integrated menu file 120 and the integrated configuration file 110 (S24). Then, the request distribution unit 105-22 of the Web UI framework bundle 105-2 registers a list of URLs based on the updated integrated configuration file 110 with the HTTP service bundle 105-1 (S25). As a result, HTTP requests for Web UI content bundles 105-3 are treated as effective on the Web UI framework bundle 105-2.

As described above, the MFP 1 of the first embodiment is capable of creating a single Web site by appropriately integrating Web UI content bundles 105-3 each having a significantly high degree of independence.

### (b) Second Embodiment

Next is described the second embodiment. In the second embodiment, features different from the first embodiment are explained.

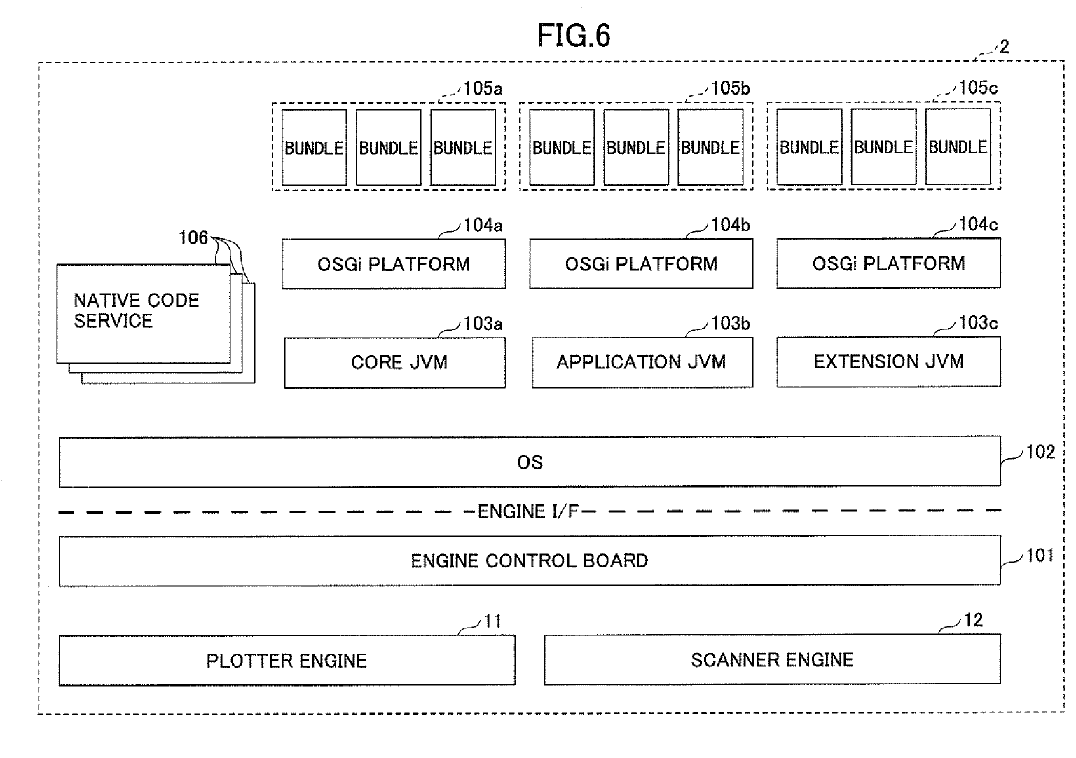

FIG. 6 illustrates a structural example of a program execution environment of an MFP according to the second embodiment. In FIG. 6, the same reference numerals are given to the components which are common to those of FIG. 1, and their explanations are accordingly omitted.

As shown in FIG. 6, an MFP 2 includes three JVMs 103 of a core JVM 103a, an application JVM 103b and an extension JVM 103c, and also includes components (the OSGi platform 104 and the bundles 105) described in FIG. 1 with respect to each JVM 103. These OSGi platforms 104 and bundles 105 on the respective JVMs 103 are distinguished by “a”, “b” or “c” added to the end of each reference numeral.

Basically, the functions (implementation contents) of all JVMs 103 are the same. Note however that, with respect to each JVM 103, an access authority to other JVM environments or native environments is different from the other JVMs 103. Specifically, the core JVM 103a offers an execution environment for bundles 105 having the highest reliability, such as a bundle 105 created by a maker or the like of the MFP 2. Bundles 105 that operate on the core JVM 103a are referred to as “core bundles 105a” for the sake of convenience. The core bundles 105a are able to, for example, directly call (use) all functions offered by the native code services 106 and the engine control board 102. Note that a limit may be placed on the use of the native code services 106 or the engine control board 102 by the core bundles 105a.

The application JVM 103b offers an execution environment for bundles 105 which have lower reliability than the core bundles 105a or whose access to resources of the MFP 2 should be strictly limited. Bundles 105 that operate on the application JVM 103b are referred to as “application bundles 105b” for the sake of convenience. The application bundles 105b are able to directly use functions offered by the native code services 106. Note however that, when compared to the core bundles 105a, a strict limit is placed on the use of the native code services 106 by the application bundles 105b. The application bundles 105b are able to directly use all or part of functions of the core bundles 105a. Note that calls between different JVM environments may adopt publicly known technologies, such as RMI (Remote Method Invocation).

The extension JVM 103c offers an execution environment for bundles 105 which have lower reliability than the application bundles 105b or whose access to resources of the MFP 2 should be strictly limited. Bundles 105 that operate on the extension JVM 103c are referred to as “extension bundles 105c” for the sake of convenience. The extension bundles 105c are able to directly use functions of the core bundles 105a and the application bundles 105b within a predetermined limit range. Note however that the extension bundles 105c are not allowed to directly use functions offered by the native code services 106.

Thus, in the MFP 2, the access authority of each bundle 105 is limited on a JVM environment basis. In the example of FIG. 6, the MFP 2 includes three JVMs 103, and the security level of each bundle 105 can be classified into one of three levels according to a JVM 103 on which the bundle 105 is caused to operate. Accordingly, it is possible to easily perform access control of each application when compared to the case in which the access authority is limited with respect to each bundle 105. Note that the MFP 2 may include two JVMs 103 or four or more JVMs 103 according to specifications of the hardware resources of the MFP 2. Two security levels may be provided in the case of two JVMs 103, and four or more security levels may be provided in the case of four JVMs 103.

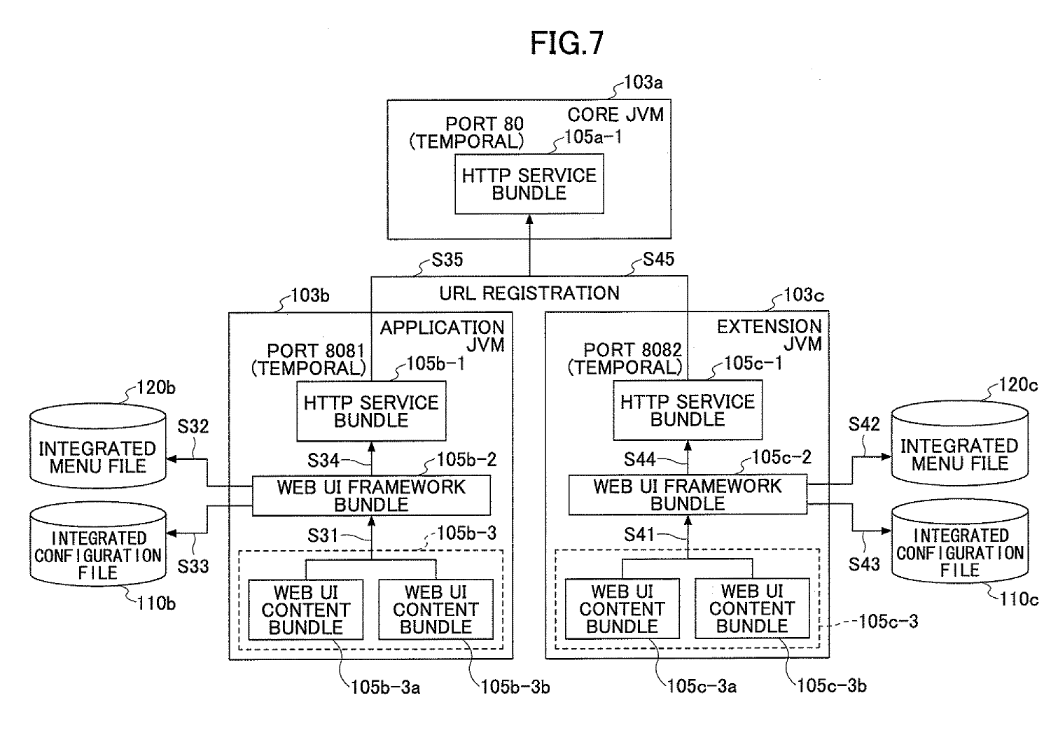

In the above described environment, a Web site is achieved by the following bundle structure according to the second embodiment. FIG. 7 shows an example of a bundle structure for achieving an integrated Web site according to the second embodiment.

In FIG. 7, the HTTP service bundle 105a-1 is implemented on the core JVM 103a by the core bundle 105a. On the other hand, the respective bundle structures on the application JVM 103b and the extension JVM 103c are the same as the structure of the bundles 105 on the JVM 103 of the first embodiment. That is, on the application JVM 103b, an HTTP service bundle 105b-1, a Web UI framework bundle 105b-2 and one or more Web UI content bundles 105b-3 of the application bundles 105b are implemented. On the extension JVM 103c, an HTTP service bundle 105c-1, a Web UI framework bundle 105c-2, and one or more Web UI content bundle 105c-3 of the execution bundles 105c are implemented.

The function of each bundle 105 is as described in the first embodiment. Port numbers for receiving HTTP requests are different among the HTTP service bundles 105a-1, 105b-1 and 105c-1, and only the port of the HTTP service bundle 105a-1 is open to the outside (on the network).

According to the second embodiment, there are two Web UI framework bundles 105-2 of the Web UI framework bundles 105b-2 and 105c-2. Accordingly, the second embodiment requires a scheme for integrating two Web UI framework bundles 105-2. An example for achieving such a scheme is described next.

Referring to FIG. 7, first are explained processes performed at the time of generating the integrated configuration file 110 and the integrated menu file 120.

Each Web UI content bundle 105b-3 on the application JVM 103b outputs its menu file and configuration file to (the file integration unit of) the Web UI framework bundle 105b-2 (S31). Similarly, each Web UI content bundle 105c-3 on the extension JVM 103c outputs its menu file and configuration file to (the file integration unit of) the Web UI framework bundle 105c-2 (S41).

Subsequently, the Web UI framework bundle 105b-2 generates an integrated menu file 120b by integrating the collected menu files (S32). In addition, the Web UI framework bundle 105b-2 generates or updates an integrated configuration file 110b by the collected configuration files (S33). Similarly, the Web UI framework bundle 105c-2 generates an integrated menu file 120c by integrating the collected menu files (S42). In addition, the Web UI framework bundle 105c-2 generates or updates an integrated configuration file 110c by the collected configuration files (S43). Note that when the configuration files are integrated, whether there is an overlapping URL is determined as in the first embodiment.

Next, the Web UI framework bundle 105b-2 registers a list of URLs based on the integrated configuration file 110b with the HTTP service bundle 105b-1 (S34). Similarly, the Web UI framework bundle 105c-2 registers a list of URLs based on the integrated configuration file 110c with the HTTP service bundle 105c-1 (S44).

Subsequently, the HTTP service bundle 105b-1 reports its registered URL list to the HTTP service bundle 105a-1 on the core JVM 105a-1, and requests the HTTP service bundle 105a-1 to transfer HTTP requests in which URLs included in the list (hereinafter, referred to as “application URL list”) are specified (S35). Similarly, the HTTP service bundle 105c-1 reports its registered URL list to the HTTP service bundle 105a-1, and requests the HTTP service bundle 105a-1 to transfer HTTP requests in which URLs included in the list (hereinafter, referred to as “extension URL list”) are specified (S45).

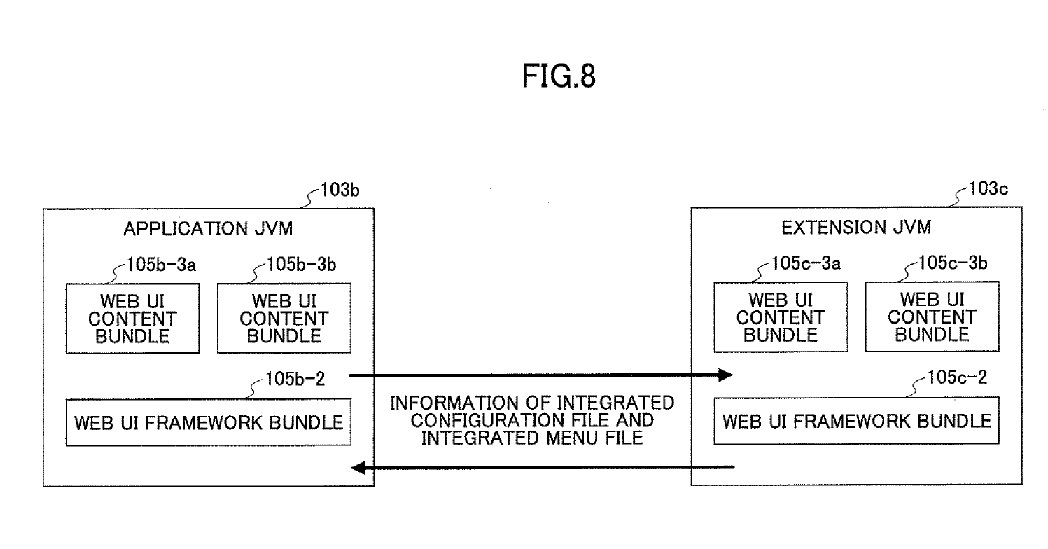

Note that the processes performed on the application JVM 103b and the extension JVM 103c are described above in parallel; however, these processes do not need to be in synchronization. Note that, as shown in FIG. 8, the Web UI framework bundle 105b-2 and the Web UI framework bundle 105c-2 exchange their management information (information stored in the integrated configuration files 110 or the integrated menu files 120) using the RMI (Remote Method Invocation) or the like at a predetermined timing (for example, at a time when the Web UI framework bundle 105b-2 or 105c-2 generates the integrated configuration file 110, or generates or updates the integrated menu file 120).

Herewith, each Web UI framework bundle 105-2 merges the content of the integrated menu file 120 (menu structure information) managed by the other Web UI framework bundle 105-2 and the content of its own integrated menu file 120 to generate a new integrated menu file 120. Accordingly, the integrated menu file 120 having the same content is managed (i.e. the menu structure information is shared) by each Web UI framework bundle 105-2. As a result, even if a Web UI content bundle 105-3 for generating the menu page 500 is implemented on each of the Web UI framework bundles 105-2, the menu pages 500 generated by the respective Web UI content bundles 105-3 have the same menu structure.

Each Web UI framework bundle 105-2 determines if there is overlapping between URLs registered in the integrated configuration file 110 managed by the other Web UI frame work bundle 105-2 and URLs registered in its own integrated configuration file 110. If there is overlapping, the overlapping URL is displayed on the operation panel or the like to prompt the operator to make a correction. Herewith, it is possible to prevent URLs from overlapping over the Web UI framework bundles 105-2 (i.e. over the JVMs 103).

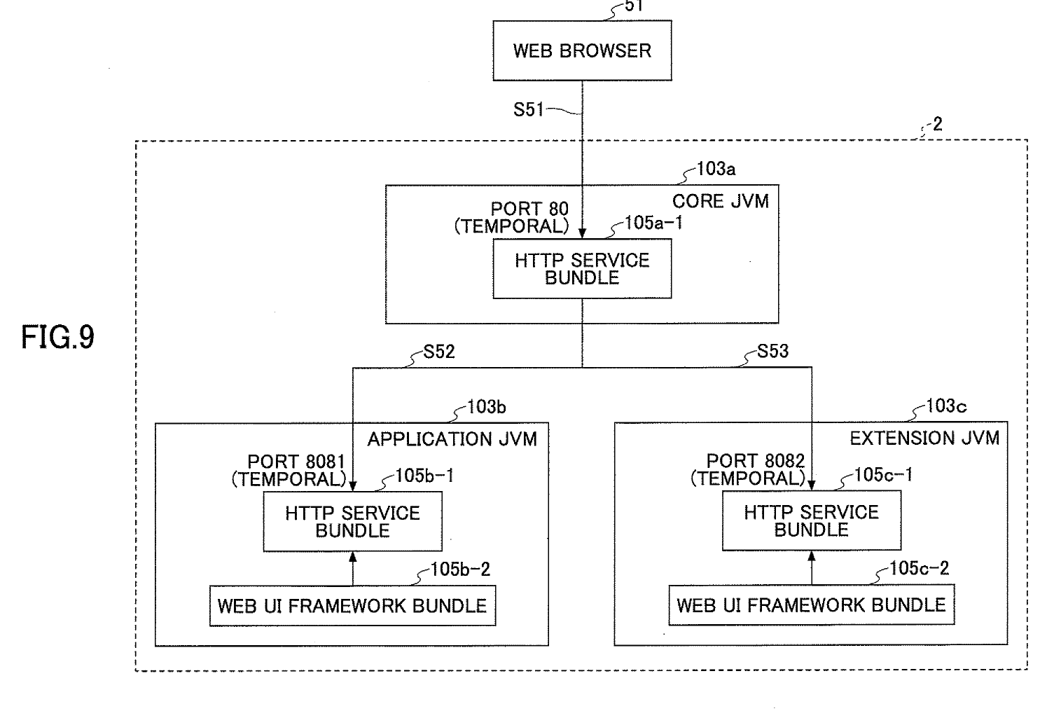

Next is described a process performed when an HTTP request is received. FIG. 9 illustrates, according to the second embodiment, operating procedures performed when an HTTP request is received.

An HTTP request from a Web browser 51 is received by the HTTP service bundle 105a-1 on the core JVM 103a (S51). Since only the port of the HTTP service bundle 105a-1 is open to the outside as described above, HTTP requests for the Web UI content bundles 105b-3 and 105c-3 of the respective JVMs 103 are collectively received by the HTTP service bundle 105a-1. The HTTP service bundle 105a-1 determines a destination of each received HTTP request based on the URL specified in the HTTP request and the application URL list or the extension URL list. That is, in the case where the received URL is included in the application URL list, the HTTP service bundle 105a-1 transmits the HTTP request to the HTTP service bundle 105b-1 (S52). On the other hand, in the case where the received URL is included in the extension URL list, the HTTP service bundle 105a-1 transmits the HTTP request to the HTTP service bundle 105c-1 (S53). The subsequent operating procedures are the same as those in the first embodiment, and their explanations are therefore omitted here.

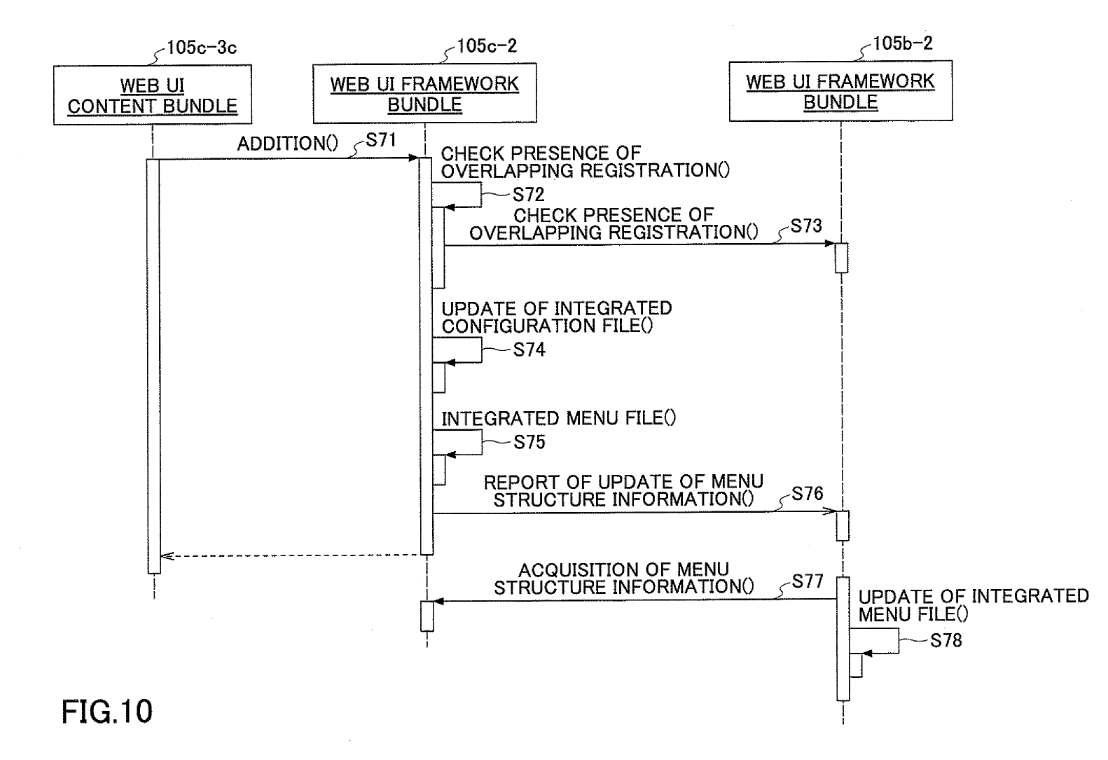

Next is described a process performed when an extension bundle 105c which is a new Web UI content bundle 105c-3 is installed (added) during the operation of the MFP 2. FIG. 10 is a sequence diagram illustrating, according to the second embodiment, operating procedures performed when a Web UI content bundle is added.

Assume that a Web UI content bundle 105c-3c is newly installed on the extension JVM 103c. Following the installation, the Web UI content bundle 105c-3c requests the Web UI framework bundle 105c-2 to newly register its own menu file and configuration file (S71). Subsequently, the Web UI framework bundle 105c-2 determines, based on the newly added configuration file of the Web UI content bundle 105c-3c and the integrated configuration file 110c, whether there is an overlapping URL (S72). The Web UI framework bundle 105c-2 transmits the configuration file of the Web UI content bundle 105c-3c to the Web UI framework bundle 105b-2, and requests the Web UI framework bundle 105b-2 to determine whether there is an overlapping URL (S73). If there is an overlapping URL, the Web UI framework bundle 105c-2 quits the process and displays on the operation panel a message or the like urging change of the overlapping URL.

Subsequently, the Web UI framework bundle 105c-2 adds contents of the configuration file and the menu file of the Web UI content bundle 105c-3c to the integrated configuration file 110c and the integrated menu file 120c (S74 and S75). Note that requests for cancellation and re-registration of a URL list are placed to the HTTP service bundle 105c-1 before and after, respectively, the update of the integrated configuration file 110c and the integrated menu file 120c, as in the case of the first embodiment.

Next, the Web UI framework bundle 105c-2 reports the update of the menu structure information to the Web UI framework bundle 105b-2 (S76). In response to the report, the Web UI framework bundle 105b-2 obtains the menu structure information (menu structure information stored in the updated menu file 120c) from the Web UI framework bundle 105c-2 (S77), and merges the obtained menu structure information with the integrated menu file 120b (S78).

As described above, the MFP 2 of the second embodiment is capable of creating an integrated Web site for the entire MFP 2 even if the Web UI framework bundles 105-2 are implemented separately on the multiple JVMs 103.

Thus, according to one aspect of the present invention, it is possible to provide an image forming apparatus, an information processing method and a program capable of integrating multiple Web applications.

While the embodiments of the present invention have been described above, it should be noted that the present invention is not limited to the above-described embodiments, and covers all such modifications and alterations without departing from the scope and spirit of the present invention described in the appended claims.

This application is based on Japanese Patent Application No. 2008-143132 filed on May 30, 2008, the contents of which are hereby incorporated herein by reference.

What is claimed is:

1. An image forming apparatus comprising:
a plurality of program executing units;
a plurality of Web page generating units, each corresponding to one of the program executing units and configured to execute a process that corresponds to an HTTP request and generate a Web page for displaying information indicating a result of the process;
a plurality of menu information integrating units, each corresponding to one of the program executing units and configured to obtain, from each Web page generating unit corresponding to the corresponding program executing unit, a URL of the Web page generating unit and menu item display information provided for allowing use of the Web page generating unit, integrate and store the obtained menu item display information in a first file specific to the corresponding program executing unit, and merge, with the first file, information obtained from another first file specific to another program executing unit; and
a menu page generating unit configured to generate, based on information stored in the merged first file, a Web page including menu items provided for allowing use of the Web page generating units.

2. The image forming apparatus as claimed in claim 1 further comprising:
a plurality of URL information integrating units, each corresponding to one of the program executing units and configured to obtain URL correspondence information from each Web page generating unit corresponding to the corresponding program executing unit and integrate and store the obtained URL correspondence information in a second file specific to the corresponding program executing unit; and
a plurality of request distributing units each corresponding to one of the program executing units and configured to determine, based on the second file, a Web page generating unit corresponding to a URL which is specified in a received HTTP request, and cause the determined Web page generating unit to execute a process corresponding to the received HTTP request.

3. The image forming apparatus as claimed in claim 2, wherein the URL information integrating unit determines whether there is URL overlapping in the obtained URL correspondence information, and performs the integration of the obtained URL correspondence information if there is no URL overlapping.

4. The image forming apparatus as claimed in claim 3, wherein the URL information integrating unit determines whether there is the URL overlapping by comparing URLs included in the URL correspondence information stored in the second file and URLs included in URL correspondence information obtained from another second file specific to another program executing unit, and causes an operation panel to make a display about detection of URL overlapping if there is URL overlapping.

5. The image forming apparatus as claimed in claim 2, further comprising a request receiving unit configured to collectively receive HTTP requests placed to the Web page generating units each corresponding to one of the program executing units, wherein the request receiving unit obtains the URL correspondence information stored in the second file specific to each of the program executing units, determines, based on the obtained URL correspondence information, a Web page generating unit corresponding to each of the received HTTP requests, and reports each of the received HTTP requests to a request distributing unit corresponding to a program executing unit to which the determined Web page generating unit corresponds.

6. An information processing method applied to an image forming apparatus including a plurality of program executing units and a plurality of Web page generating units, each corresponding to one of the program executing units and configured to execute a process that corresponds to an HTTP request and generate a Web page for displaying information indicating a result of the process, the information processing method comprising:
a menu information integrating step of obtaining with respect to each of the program executing units, from each Web page generating unit corresponding to the program executing unit, a URL of the Web page generating unit and menu item display information provided for allowing use of the Web page generating unit, integrating and storing the obtained menu item display information in a first file specific to the corresponding to the program executing unit, and merging, with the first file, information obtained from another first file specific to another program executing unit; and
a menu page generating step of generating, based on information stored in the merged first file, a Web page including menu items provided for allowing use of the Web page generating units.

7. The information processing method as claimed in claim 6, further comprising:
a URL information integrating step of obtaining, with respect to each of the program executing units, URL correspondence information from each Web page generating unit corresponding to the program executing unit, and integrating and storing the obtained URL correspondence information in a second file specific to the corresponding program executing unit; and
a request distributing step of determining, based on the second file, a Web page generating unit corresponding to a URL which is specified in a received HTTP request, and causing the determined Web page generating unit to execute a process corresponding to the received HTTP request.

8. The information processing method as claimed in claim 7, wherein the URL information integrating step determines whether there is URL overlapping in the obtained URL correspondence information, and performs the integration of the obtained URL correspondence information if there is no URL overlapping.

9. The information processing method as claimed in claim 8, wherein the URL information integrating step determines whether there is URL overlapping by comparing URLs included in the URL correspondence information stored in the second file and URLs included in URL correspondence information obtained from another second file specific to another program executing unit, and causes an operation panel to make a display about detection of URL overlapping if there is URL overlapping.

10. The information processing method as claimed in claim 7, further comprising a request receiving step of collectively receiving HTTP requests placed to the Web page generating units, each corresponding to one of the program executing units, wherein the request receiving step obtains the URL correspondence information stored in the second file specific to each of the program executing units, determines, based on the obtained URL correspondence information, a Web page generating unit corresponding to each of the received HTTP requests, and reports each of the received HTTP requests to a request distributing unit corresponding to a program executing unit to which the determined Web page generating unit corresponds.

11. A program executed by an image forming apparatus including a plurality of program executing units and a plurality of Web page generating units, each corresponding to one of the program executing units and configured to execute a process that corresponds to an HTTP request and generate a Web page for displaying information indicating a result of the process, the program causing the image forming apparatus to execute:
a menu information integrating step of obtaining with respect to each of the program executing units, from each Web page generating unit corresponding to the program executing unit, a URL of the Web page generating unit and menu item display information provided for allowing use of the Web page generating unit, integrating and storing the obtained menu item display information in a first file specific to the corresponding to the program executing unit, and merging, with the first file, information obtained from another first file specific to another program executing unit; and
a menu page generating step of generating, based on information stored in the merged first file, a Web page including menu items provided for allowing use of the Web page generating units.

12. The program as claimed in claim 11, further comprising:
a URL information integrating step of obtaining, with respect to each of the program executing units, URL correspondence information from each Web page generating unit corresponding to the program executing unit, and integrating and storing the obtained URL correspondence information in a second file specific to the corresponding program executing unit; and
a request distributing step of determining, based on the second file, a Web page generating unit corresponding to a URL which is specified in a received HTTP request, and causing the determined Web page generating unit to execute a process corresponding to the received HTTP request.

13. The program as claimed in claim 12, wherein the URL information integrating step determines whether there is URL overlapping in the obtained URL correspondence information, and performs the integration of the obtained URL correspondence information if there is no URL overlapping.

14. The program as claimed in claim 13, wherein the URL information integrating step determines whether there is URL overlapping by comparing URLs included in the URL correspondence information stored in the second file and URLs included in URL correspondence information obtained from another second file specific to another program executing unit, and causes an operation panel to make a display about detection of URL overlapping if there is URL overlapping.

15. The program as claimed in claim 12, further comprising a request receiving step of collectively receiving HTTP requests placed to the Web page generating units each corresponding to one of the program executing units, wherein the request receiving step obtains the URL correspondence information stored in the second file specific to each of the program executing units, determines, based on the obtained URL correspondence information, a Web page generating unit corresponding to each of the received HTTP requests, and reports each of the received HTTP requests to a request distributing unit corresponding to a program executing unit to which the determined Web page generating unit corresponds.
